(19) United States
(12) Patent Application Publication
(10) Pub. No.: US 2017/0299930 A1
(43) Pub. Date: Oct. 19, 2017

(54) DISPLAY PANEL AND MANUFACTURING METHOD THEREOF, AND DISPLAY DEVICE

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Xiangdong WEI, Beijing (CN); Yun QIU, Beijing (CN); Lihua LIU, Beijing (CN); Xiang FENG, Beijing (CN)

(21) Appl. No.: 15/513,467

(22) PCT Filed: Jan. 22, 2016
(86) PCT No.: PCT/CN2016/071762

§ 371 Date: Mar. 22, 2017

(30) Foreign Application Priority Data
Sep. 2, 2015 (CN) 201510556866.5

(51) Int. Cl. G02F 1/1362; G09G 3/36

(52) U.S. Cl. CPC G02F 1/136286; G09G 3/3648; G02F 1/136259; G02F 2001/136272; G09G 2300/0408; G09G 2330/08

(57) ABSTRACT

A display panel and a manufacturing method thereof, and a display device are provided. The display panel includes an array substrate and an opposite substrate. The array substrate includes signal lines including a gate line and/or a source line. The opposite substrate includes auxiliary lines corresponding to the signal lines, and the signal lines are electrically connected to the corresponding auxiliary lines. The signal lines are insulated from each other. The signal lines and the electrically connected auxiliary lines are configured to transmit signals to electrodes electrically connected to the signal lines.

### TECHNICAL FIELD

Embodiments of the present disclosure relate to a display panel, a manufacturing method thereof, and a display device.

### BACKGROUND

A thin film transistor liquid crystal display (TFT-LCD) is described as an example that includes an array substrate, an opposite substrate and a liquid crystal layer located between them. The operating principle is mainly to control the arrangement state of liquid crystal molecules with an electric field between pixel electrodes and common electrodes to control light exiting amount of light emitted by the backlight after passing the liquid crystal layer, so as to display desired images.

### SUMMARY

Embodiments of the present disclosure provide a display panel, a manufacturing method thereof, and a display device.

According to at least one embodiment, a display panel is provided, including an array substrate and an opposite substrate. The array substrate includes signal lines including gate routes and/or source routes; the opposite substrate includes auxiliary routes corresponding to the signal lines, any signal line being electrically connected with its corresponding auxiliary route, the signal lines being insulated from each other, and any signal line and an auxiliary route electrically connected with it being configured to transmit signals to an electrode electrically connected with the signal line.

In a possible implementation, the signal lines include source routes including data lines in a display area; and the auxiliary routes include first auxiliary routes corresponding to the source routes.

In second possible implementation, the source routes further include data line leads electrically connected with the data lines and located in the wiring area; and the first auxiliary routes have projections overlapping those of the data lines and the data line leads in a direction perpendicular to the display panel and are electrically connected by at least two separate connection points.

In a third possible implementation, the signal lines include gate routes including gate lines in the display area; and the auxiliary routes include second auxiliary routes corresponding to the gate routes.

In a fourth possible implementation, the gate routes further include gate line leads electrically connected with the gate lines and located in the wiring area, one end of each gate line being electrically connected with the gate line lead, and other end being electrically connected with the gate line lead or the second auxiliary route.

In a fifth possible implementation, for any gate line, both ends thereof are electrically connected with a gate line lead; and projection of the second auxiliary routes overlap at least projections of the gate line leads in the direction perpendicular to the display panel.

In a sixth possible implementation, for any gate line, one end thereof is electrically connected with a gate line lead; and with respect to the midline of the display panel perpendicular to the gate line, the gate line leads are disposed alternately and the second auxiliary routes and the gate line leads are disposed symmetrically.

In a seventh possible implementation, in a direction perpendicular to the gate lines, the wiring area includes a first wiring area and a second wiring area opposite to each other; and the gate line leads extend into the first wiring area; and in case that the signal lines include source routes and the source routes further include data line leads, the data line leads extend into the first wiring area.

In an eighth possible implementation, in case the auxiliary routes further include first auxiliary routes, the first auxiliary routes and the second auxiliary routes are disposed in a same layer.

In a ninth possible implementation, any signal line and an auxiliary route corresponding to it are electrically connected by conductive adhesive in the wiring area.

According to an embodiment of the present disclosure, a manufacturing method of a display panel, including preparing an array substrate and an opposite substrate; the array substrate including signal lines, the signal lines including gate routes and/or source routes, the signal lines being insulated from each other, and the opposite substrate includes auxiliary routes corresponding to the signal lines; and assembling the array substrate and the opposite substrate to form a cell to electrically connect any signal line with an auxiliary route corresponding to it by conductive adhesive, the signal line and the auxiliary route electrically connected with it being used to transmit signals to an electrode electrically connected with the signal line.

In a first possible implementation, the signal lines include source routes and gate routes, and the auxiliary routes includes first auxiliary routes corresponding to the source routes and second auxiliary routes corresponding to the gate routes, the first auxiliary routes and the second auxiliary routes being formed by a single patterning process.

In a second possible implementation, the source routes include data lines in the display area and data line leads in the wiring area; projections of the first auxiliary routes overlap those of the data lines and the data line leads in a direction perpendicular to the display panel and are electrically connected by at least two separate connection points; the gate routes include gate lines in the display are; and the second auxiliary routes are located in the wiring area.

In accordance to an embodiment of the present disclosure, a display device is provided, including the display panel and a drive module configured to provide signals to signal lines.

### BRIEF DESCRIPTION OF THE DRAWINGS

Embodiments of the present disclosure will be described in more detail below with reference to accompanying drawings to allow an ordinary skill in the art to more clearly understand embodiments of the present disclosure, in which:

FIG. 1 is a structural schematic diagram of an array substrate;

FIG. 2a is a structural schematic diagram I of an array substrate provided in an embodiment of the present disclosure;

FIG. 2b is a structural schematic diagram I of an opposite substrate corresponding to FIG. 2a;

FIG. 2c is a structural schematic diagram II of an opposite substrate corresponding to FIG. 2a;

FIG. 3a is a structural schematic diagram II of an array substrate provided in an embodiment of the present disclosure;

FIG. 3b is a structural schematic diagram of an opposite substrate corresponding to FIG. 3a;

FIG. 4a is a structural schematic diagram III of an array substrate provided in an embodiment of the present disclosure;

FIG. 4b is a structural schematic diagram of an opposite substrate corresponding to FIG. 4a;

FIG. 5a is a structural schematic diagram IV of an array substrate provided in an embodiment of the present disclosure;

FIG. 5b is a structural schematic diagram of an opposite substrate corresponding to FIG. 5a;

FIG. 6a is a structural schematic diagram V of an array substrate provided in an embodiment of the present disclosure;

FIG. 6b is a structural schematic diagram of an opposite substrate corresponding to FIG. 6a;

FIG. 7a is a structural schematic diagram VI of an array substrate provided in an embodiment of the present disclosure; and

FIG. 7b is a structural schematic diagram of an opposite substrate corresponding to FIG. 7a.

### DETAILED DESCRIPTION

Technical solutions according to the embodiments of the present disclosure will be described clearly and fully as below in conjunction with the accompanying drawings of embodiments of the present disclosure. It is apparent that the described embodiments are just a part but not all of the embodiments of the disclosure. Based on the described embodiments herein, a person of ordinary skill in the art can obtain other embodiment(s), without any creative work, which shall be within the scope of the present disclosure.

Unless otherwise defined, all the technical and scientific terms used herein have the same meanings as commonly understood by a person of ordinary skill in the art to which the present disclosure belongs. The terms, such as “first,” “second,” or the like, which are used in the description and the claims of the present disclosure, are not intended to indicate any sequence, amount or importance, but for distinguishing various components. Also, the terms, such as “a,” “an,” “the,” or the like, are not intended to limit the amount, but may be for indicating the existence of at lease one. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not intended to define a physical connection or mechanical connection, but may include an electrical connection/coupling, directly or indirectly. The terms, “on,” “under,” or the like are only used to indicate relative position relationship, and when the position of the object which is described is changed, the relative position relationship may be changed accordingly.

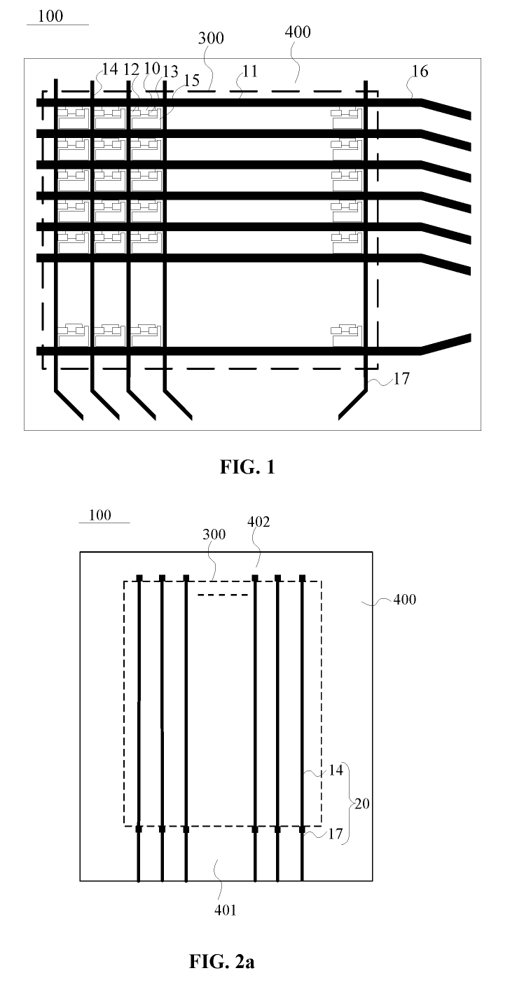

As shown in FIG. 1, the array substrate 100 includes gate electrodes 10 in the display area 300, gate lines 11 connected with gate electrodes, a semiconductor active layer (not shown), source electrodes 12, drain electrodes 13, data lines 14 connected with source electrodes 12, and pixel electrodes 15 connected with drain electrodes 13. Furthermore, it includes gate line leads 16 connected with gate lines in the wiring area 400 and data line leads 17 connected with data lines 14.

The inventor found that when a liquid crystal display is for example used in extreme environments, such as −40 or lower, or 80 [symbol] or higher, or dropped by accident, the screen will be broken such that wires, such as gate lines 11, gate line leads 16, data lines 14 and data line leads 17, therein will be broken and cannot be used normally.

An embodiment of the present disclosure provides a display panel including an array substrate and an opposite substrate. The array substrate includes signal lines including gate routes and/or source routes; the opposite substrate includes auxiliary routes corresponding to the signal lines, in which ally signal line is electrically connected with its corresponding auxiliary route and the signal lines are insulated from each other; and any signal line and the auxiliary route electrically connected with it are configured to transmit signals to the electrode electrically connected with the signal line.

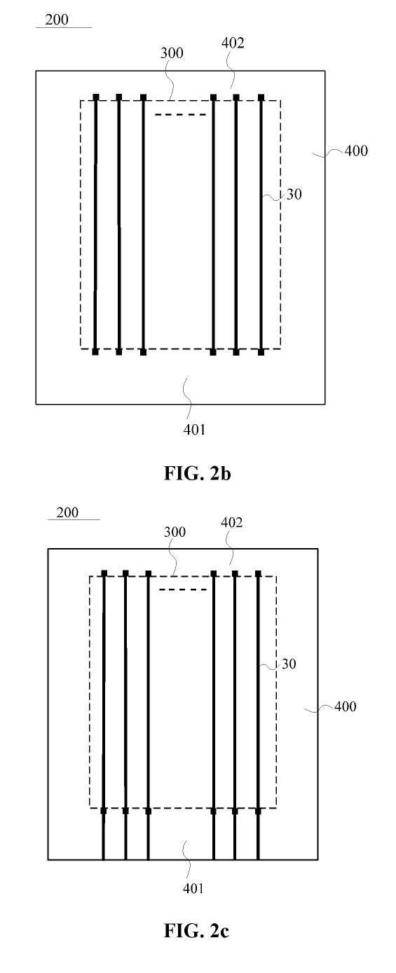

For example, as shown in FIG. 2a, signal lines on the array substrate 100 may include only source routes 20, in this case, as shown in FIGS. 2b and 2c, auxiliary routes on the opposite substrate 200 include first auxiliary routes 30 corresponding to the source routes 20.

In this way, electrical connection between any signal line and the auxiliary route corresponding to it refers to the electrical connection between any source route 20 and the first auxiliary route 30 corresponding to it. That any one signal line and the auxiliary route electrically connected with it are configured to transmit signals to the electrode electrically connected with the signal line refers to any one source route 20 and the first auxiliary route 30 electrically connected with it are configured to transmit signals to the source electrode electrically connected with the source route 20.

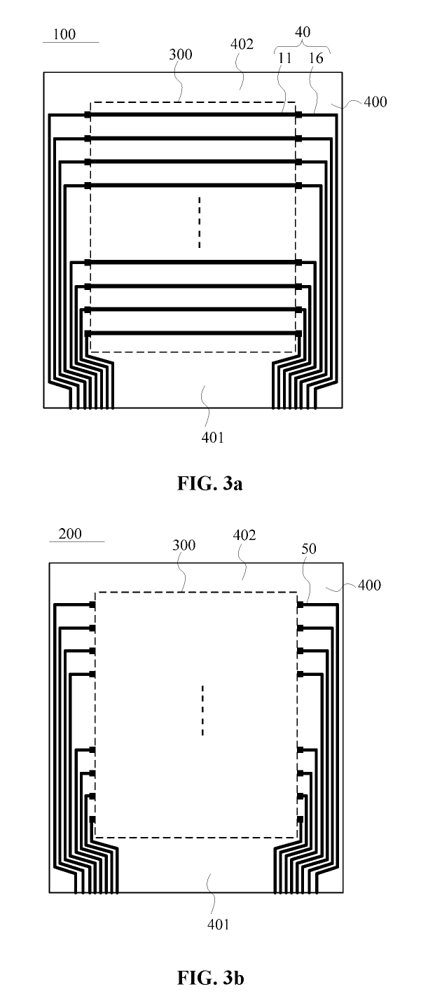

As shown in FIGS. 3a, 4a and 5a, signal lines on the array substrate 100 may only include gate routes 40, in this case, as shown in FIGS. 3b, 4b and 5b, auxiliary routes on the opposite substrate 200 include second auxiliary routes 50 corresponding to the gate routes 40.

In this way, electrical connection between any signal line and the auxiliary route corresponding to it refers to the electrical connection between any gate route 40 and the second auxiliary route 50 corresponding to it. That any one signal line and the auxiliary route electrically connected with it are configured to transmit signals to the electrode electrically connected with the signal line refers to any one gate route 40 and the second auxiliary route 50 electrically connected with it are configured to transmit signals to the gate electrode electrically connected with the gate route 40.

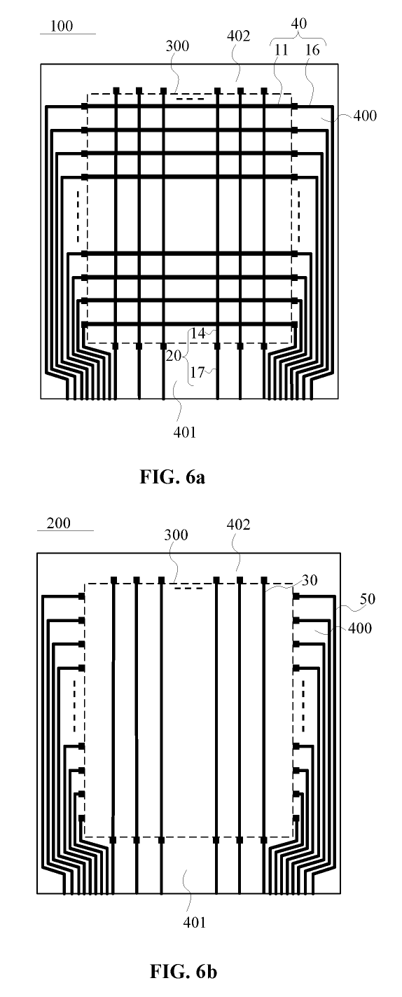

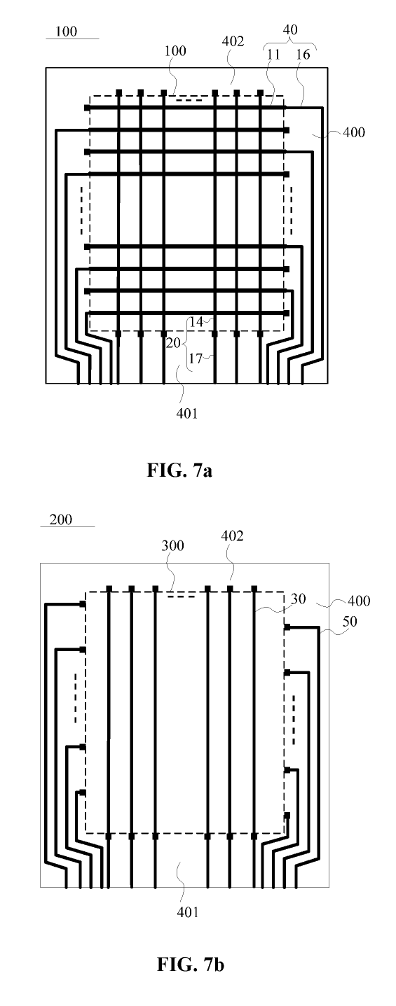

As shown in FIGS. 6a and 7a, signal lines on the array substrate 100 may include both source routes 20 and gate routes 40, in this case, as shown in FIGS. 6b and 7b, the auxiliary routes on the opposite substrate 200 include first auxiliary routes 30 and second auxiliary routes 50 corresponding to source routes 20 and the gate routes 40, respectively.

In this way, electrical connection between any signal line and the auxiliary route corresponding to it refers to the electrical connection between any source route 20 and the first auxiliary route 30 corresponding to it, and the electrical connection between ally gate route 40 and the second auxiliary route 50 corresponding to it. That any one signal line and the auxiliary route electrically connected with it are configured to transmit signals to the electrode electrically connected with the signal line refers to any one source route 20 and the first auxiliary route 30 electrically connected with it are configured to transmit signals to the source electrode electrically connected with the source route 20, and any one gate route 20 and the second auxiliary route 50 electrically connected with it are configured to transmit signals to the gate electrode electrically connected with the source route 20.

It is noted that, first, the source routes 20 may include only data lines 14, and may also include data line routes 17 based on this. Similarly, the gate routes 40 may only include gate lines 11, and may also include gate line leads 16 based on this.

Secondly, for any one electrode, the auxiliary route electrically connected with it corresponds to the signal line.

For example, under the situation that any signal line and the auxiliary route electrically connected with it are configured to transmit signals to the electrode electrically connected with the signal line, if the signal line itself can transmit signals to the electrode electrically connected with it, the auxiliary route corresponds to the signal line refers to that, for a single side driving mode, projections of the auxiliary routes and the signal lines are overlapped each other in the direction perpendicular to the display panel; and for a double side driving mode, on the one hand, projections of the auxiliary routes and the signal lines may be overlapped with each other in the direction perpendicular to the display panel, and on the other hand, the auxiliary routes may also function as connecting wires for connecting the driving ICs and the signal lines. If the signal line itself is not sufficient to transmit signals to the electrode electrically connected with it, the auxiliary route corresponds to the signal line refers to that the auxiliary route serves as a connecting wire for connecting the driving IC and the signal line.

Those skilled in the art should understand that, based on an objective of the embodiments of the present disclosure, projections of the auxiliary routes and the signal lines overlap in the direction perpendicular to the display panel, which implies that projections of the auxiliary routes on the base substrate of the opposite substrate are parallel to projections of the signal lines on the base substrate of the array substrate.

Thirdly, the electrical connection between any signal line and the auxiliary route corresponding to it is not limited. For example, the electrical connection may be implemented by conductive adhesive in the wiring area.

For the array substrate 100, it may be divided into a display area 300 and a wiring area 400 located at the periphery of the display area 300.

In this way, the area of the opposite substrate 200 that corresponds to the wiring area 400 of the array substrate 100 is also referred to as a wiring area 400.

Fourthly, the small black boxes in the accompanying drawings only schematically represent connection points between signal lines on the array substrate 100 and auxiliary routes on the opposite substrate 200, which are set only for clearness and may not exist in practical products, or such connection points are not limited to the number in the figures.

An embodiment of the present disclosure provides a display panel. In the art in which routes including connecting wires in addition to gate lines or data lines are provided only on the array substrate, when the screen is broken, since there are many pattern layers on the array substrate, stress is concentrated to result in broken routes. By disposing auxiliary routes on the opposite substrate 200 corresponding to signal lines on the array substrate 100, the embodiments of the present disclosure can address the problem in the art that signals cannot normally transmitted due to broken lines.

Optionally, as shown in FIG. 2a, the signal lines on the array substrate 100 include source routes 20 including data lines 14 on the display area 300. As shown in FIGS. 2b and 2c, the auxiliary routes on the opposite substrate 200 include the first auxiliary routes 30 corresponding to the source routes 20.

For example, when the signal line includes a source route 20, the electrode electrically connected with the source route 20 is the source electrode, in this case, signals must be provided to the source electrode through the data line 14 electrically connected directly with the source electrode and the first connecting wire for connecting the driving IC and the data line 14.

In this way, when the source route 20 only includes the data line 14 in the display area 300, it needs to transmit signals of driving IC to the source electrode through the first auxiliary route 30 corresponding to the source route 20. That is, the first auxiliary route 30 serves as the first connecting wire for transmitting signals of driving IC to the data line 14 and transmitting them from the data line 14 to the source electrode. For example, the circuit board including the driving IC may be laminated on the opposite substrate 200.

It is noted that the first auxiliary route 30 includes a part that has an overlapped projection with the data line 14 in the direction perpendicular to the display panel in addition to a part serving as connecting wire, as shown in FIG. 2c. But the embodiments of the present disclosure are not limited thereto.

With reference to FIG. 2a, when the source routes 20 includes data lines 14 in the display area 300 and data line leads 17 in the wiring area 400, since signals of the driving IC may be transmitted to the data lines 14 through data line leads 17, the data line leads 17 function as the first connecting wires. In this way, since the source routes 20 are electrically connected with their corresponding first auxiliary routes 30, it is enough to simply have projections of the first auxiliary routes 30 and the data lines 14 and/or data line leads 17 overlapped with each other in the direction perpendicular to the display panel and electrically connected by at least two separate connection points. For example, the circuit board including the driving IC may be laminated on the array substrate 100. At least one connection point is located at an end part of the first auxiliary routes 30.

It is noted that FIG. 2b shows that projections of the first auxiliary routes 30 and data lines 14 in the direction perpendicular to the display panel overlap as an example, and FIG. 2c shows that projections of the first auxiliary routes 30 and data lines 14 and data line leads 17 in the direction perpendicular to the display panel overlap as an example.

The case of FIG. 2c is described as an example of the present disclosure. This is because that by having the first auxiliary routes 30 completely overlap source routes 20 including data lines 14 and data line leads 17, signals may be normally transmitted through the first auxiliary routes 20 except for a case that all connection points of source routes 20 are broken. For other cases, since part of the routes are distributed onto the opposite substrate 200, it is also possible to reduce the probability that signals cannot be normally transmitted due to broken lines on the array substrate 100.

Furthermore, when partial or entire first auxiliary route 30 overlaps partial or entire source route 20, since they are electrically connected to each other, it is equivalent to a case that a resistance is connected in parallel with the source route 20 and loss of voltage during the signal transmission process is reduced to some extent, which can realize a good charging and discharging effect.

Optionally, as shown in FIGS. 3a, 4a and 5a, the signal lines on the array substrate 100 include gate routes 40 including gate lines 11 in the display area 300; and as shown in FIGS. 3b, 4b and 5b, the auxiliary routes include second auxiliary routes 50 corresponding to the gate routes 40.

For example, when signal lines include gate routes 40, the electrode electrically connected with the gate route 40 is the gate electrode, in this case, signals are must provided to the gate electrode through the gate line 11 electrically connected with the gate electrode and the second connecting wire for connecting the driving IC and the gate line 11.

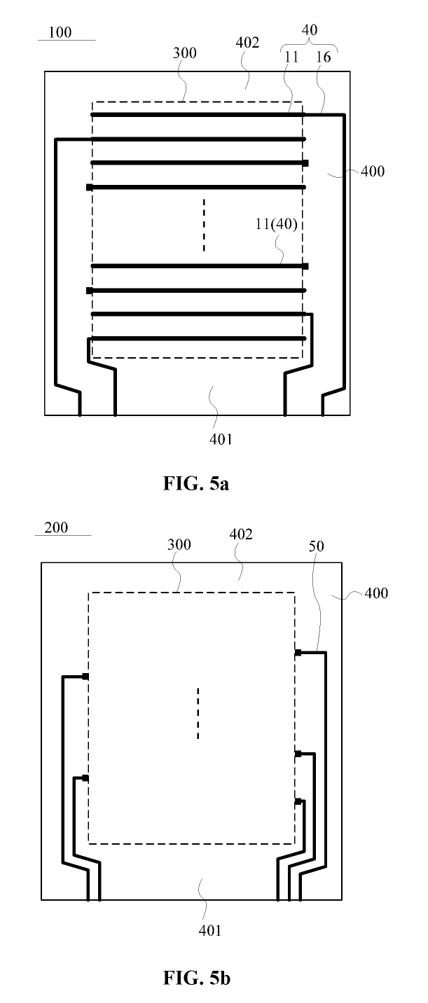

In this way, with reference to FIG. 5a, when the gate route 40 only includes the gate line 11 in the display area 300, as shown in FIG. 5b, signals of the driving IC can be transmitted to the gate electrode by the second auxiliary route 50 corresponding to the gate route 40. That is, the second auxiliary route 50 serves as the second connecting wire to transmit signals of the driving IC to the gate line 11 and then to the gate electrode from the gate line 11. For example, the circuit board including the driving IC may be laminated on the opposite substrate 200.

It is noted that with reference to FIG. 5b, the second auxiliary route 50 may only include a part that serves as the connecting wire, and may also include a part that has a projection overlapped with the projection of the gate line 11 in the direction perpendicular to the display panel. But the embodiments of the present disclosure are not limited thereto.

Furthermore, for all the gate routes 40 on the array substrate 100, as shown in FIG. 5a, it is possible that only part of gate routes 40 include only gate lines 11, and other gate routes 40 may include both gate lines 11 and gate line leads 16, and it is also possible that all gate routes 40 include only gate lines 11, which may be set as needed. But the embodiments of the present disclosure are not limited thereto.

In the embodiments of the present disclosure, since the second auxiliary routes 50 are used as connecting wires, on the one hand, it is possible to reduce the probability that signals cannot be transmitted normally due to the broken lines on the array substrate 100 to some extent, on the other hand, it is possible to reduce the number of routes in wiring area 400 of the array substrate 100 by disposing part of the routes on the opposite substrate 200, so as to reduce the width of the bezel and realize application of narrow bezel.

Exemplarily, given that the bezel width of a prior art product is 2.5 mm, the bezel width may be made to 1.5 mm by the embodiments of the present disclosure.

When the gate routes 40 include gate lines 11 in the display area 300 and gate line leads 16 in the wiring area 400, since it is possible to transmit signals of the driving IC to the gate lines 11 via the gate line leads 16, the gate line leads 16 serve as the second connecting wires. Since the second auxiliary routes 50 are electrically connected with their corresponding gate routes 40, on the one hand, it is possible to make projections of the second auxiliary routes 50 and the gate lines 11 and/or gate line leads 16 in the direction perpendicular to the display panel overlap to each other, on the other hand, if driving signals are provided to the gate electrodes with double side driving mode, and when the gate line lead 16 is connected with only one end of the gate line 11, the second auxiliary routes 50 may also function as a connecting wire connected with the other end of the gate line 11. But the embodiments of the present disclosure are not limited thereto.

Considering that the double side driving mode can accomplish signal transmission more quickly, and signal transmission will not be effected even if problem occurs with signal connection wires on one side, in the embodiment of the present disclosure, driving signals may be provided to gate electrodes by double side driving mode. That is, for example, one end of the gate line 11 is electrically connected with the gate line lead 16, and the other end is electrically connected with the gate line lead 16 or the second auxiliary route 50.

For example, with reference to FIG. 3a, for any gate line 11, its two ends are electrically connected with the gate line lead 16. In this way, as shown in FIG. 3b, for example, projection of the second auxiliary route 50 at least overlaps the projection of the gate line lead 16 in the direction perpendicular to the display panel.

It is noted that the second auxiliary route 50 of FIG. 3b only includes the part located in the wiring area 400. But the embodiments of the present disclosure are not limited thereto. The second auxiliary route 50 may also extend to the display area 300 to overlap the projection of the gate line 11 in the direction perpendicular to the display panel.

In embodiments of the present disclosure, for any gate line 11, it is possible to reduce the probability that signals cannot be transmitted normally due to broken lines by providing gate line leads 16 on their both ends. In this way, by disposing second auxiliary routes 50 that at least overlap the projections of the gate line leads 16 in the direction perpendicular to the display panel on the opposite substrate 200, it can further reduce the probability that signals cannot be transmitted normally due to broken lines.

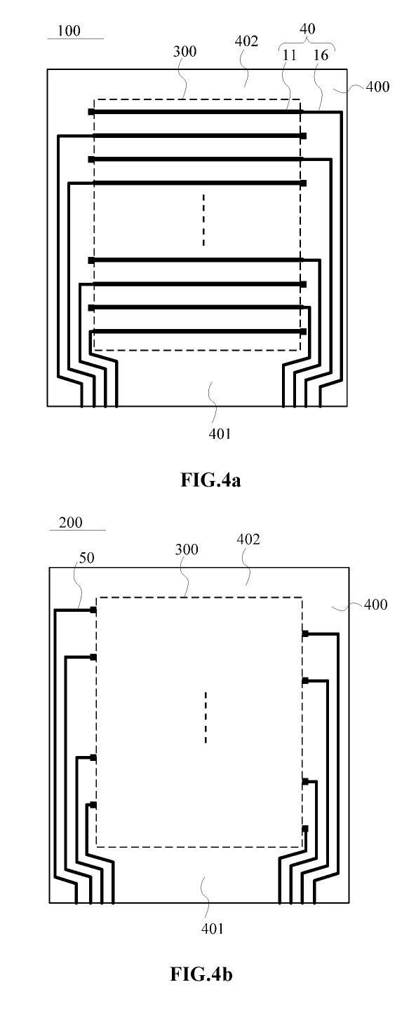

Alternatively, for any gate line 11, its one end is electrically connected with the gate line lead 16. For example, with reference to FIG. 4a, with respect to the midline of the display panel that is perpendicular to the gate line 11, the gate line leads 16 are disposed alternately. In this way, as shown in FIG. 4b, the second auxiliary routes 50 and the gate line leads 16 are disposed symmetrically.

It is noted that the second auxiliary route 50 of FIG. 4b only includes the part that is located in the wiring area 400. But the embodiments of the present disclosure are not limited thereto, the second auxiliary routes 50 may also extend to the display area 300 and overlap the projections of the gate lines 11 in the direction perpendicular to the display panel, for example.

With the embodiments of the present disclosure, on the one hand, it is possible to reduce the probability that signals cannot be transmitted normally due to broken lines, on the other hand, with respect to each gate line 11 having its two ends connected with a gate line lead 16, the embodiments of the present disclosure can reduce the number of gate line leads 16 on the array substrate 100, so as to reduce the width of the bezel and realize narrow bezel.

Exemplarily, given that the bezel width of a prior art product is 2.5 mm, the bezel width may be made to 2 mm by the embodiments of the present disclosure.

Optionally, as shown in FIGS. 6a and 7a, the signal lines on the array substrate 100 include source routes 20 including data lines 14 in the display area 300 and gate routes 40 including gate lines 14 in the display area 300; and as shown in FIGS. 6b and 7b, the auxiliary routes include first auxiliary routes 30 corresponding to the source routes 20 and second auxiliary routes 50 corresponding to the gate routes 40.

For example, with reference to FIG. 6a, the source routes 20 in the array substrate 100 may include data lines 14 and data line leads 17, the gate routes 40 include gate lines 11 and gate line leads 16 electrically connected with two ends of the gate lines 11. With reference to FIG. 6b, projections of the first auxiliary routes 30 in the opposite substrate 200 and the source routes 20 including data lines 14 and data line leads 17 in the direction perpendicular to the display panel overlap with each other, and projections of the second auxiliary routes 50 and the gate line leads 16 in the direction perpendicular to the display panel overlap.

With reference to FIG. 7a, the source routes 20 in the array substrate 100 may include data lines 14 and data line leads 17, the gate routes 40 include gate lines 11 and gate line leads 16. With respect to the display panel midline perpendicular to the gate lines 11, the gate line leads 16 are disposed alternately. With reference to FIG. 7b, projections of the first auxiliary routes 30 in the opposite substrate 200 and the source routes 20 including data lines 14 and data line leads 17 in the direction perpendicular to the display panel overlap with each other, and the second auxiliary routes 50 and the gate line leads 16 are arranged symmetrically.

It is noted that the second auxiliary route 50 in FIGS. 6b and 7b only includes the part that is located in the wiring area 400. But the embodiments of the present disclosure are not limited thereto. When the first auxiliary routes 30 and the second auxiliary routes 50 are located in different layers, the second auxiliary routes 50 can also extend to the display area 300 and overlap the projections of the gate lines 11 in the direction perpendicular to the display panel.

Furthermore, the described above lists only two cases and the embodiments of the present disclosure are not limited thereto. Other possibilities may be obtained by combining the above-mentioned cases in which signal lines include source routes 20 and signal lines include gate routes 40 and will not be described in detail herein.

Furthermore, in the direction perpendicular to the gate lines 11, the wiring area 400 includes a first wiring area 401 and a second wiring area 402 opposite to each other. The gate line leads 16 extend into the first wiring area 401; and the data line leads 17 also extend into the first wiring area 401.

In this way, by disposing a driving module including a driving IC on a side of the first wiring area 401, it is possible to provide signals to the gate line leads 16 and data line leads 17, which is in favor of realizing a design of narrow bezel.

Further, for example, the first auxiliary routes 30 and the second auxiliary routes 50 are disposed in the same layer. In this way, it is possible to reduce the number of patterning processes.

Embodiments of the present disclosure also provide a display device including any of the mentioned display panel and a driving module configured to provide signals for signal lines.

The mentioned display device may include a liquid crystal display device that may be any product or component having display function, such as a liquid crystal display, a liquid crystal TV, a digital photo frame, a mobile telephone, or a tablet computer.

Embodiments of the present disclosure also provide a manufacturing method of a display panel, including preparing an array substrate 100 and an opposite substrate 200. The array substrate 100 includes signal lines including gate routes 40 and/or source routes 20, the signal lines being insulated from each other. The opposite substrate 200 includes auxiliary lines corresponding to the signal lines. The array substrate 100 and the opposite substrate 200 are assembled to form a cell to electrically connect any signal line with its corresponding auxiliary line by conductive adhesive. Any signal line and the auxiliary line electrically connected with it are used to transmit signals to an electrode electrically connected with the signal line.

For example, with reference to FIGS. 6a and 7a, the signal lines include source routes 20 and gate routes 40. With reference to FIGS. 6b and 7b, the opposite substrate 200 includes first auxiliary routes 30 corresponding to source routes 20 and second auxiliary routes 50 corresponding to gate routes 40; and the first auxiliary routes 30 and the second auxiliary routes 50 are formed by a single patterning process.

Furthermore, for example, the source routes 20 include data lines 14 in the display area 300 and data line leads 17 in the wiring area; projections of the first auxiliary routes 30 overlap the projections of the data lines 14 and the data line leads 17 in the direction perpendicular to the display panel and are electrically connected by at least two separate connection points. The gate routes 40 include gate lines 11 in the display area 300 and may also include gate line leads 16. The second auxiliary routes 50 are located in the wiring area 400.

Embodiments of the present disclosure provide a display panel, a manufacturing method thereof and a display device. In the art in which routes including connecting wires in addition to gate lines or data lines are provided only on the array substrate, when the screen is broken, since there are many pattern layers on the array substrate, stress is concentrated to result in broken routes. By disposing auxiliary routes on the opposite substrate corresponding to signal lines on the array substrate, the embodiments of the present disclosure can address the problem in the art that signals cannot normally transmitted due to broken lines.

The described above are only exemplary embodiments of the present disclosure, and the present disclosure is not intended to be limited thereto. For one of ordinary skill in the art, various changes and alternations may be made without departing from the technical scope of the present disclosure, and all of these changes and alternations shall fall within the scope of the present disclosure. The scope of the present disclosure is defined by the appended claims.

The present application claims the priority to Chinese patent application No. 201510556866.5 entitled “Display Panel, Manufacturing Method Thereof, and Display Device” filed on Sep. 2, 2015, which is incorporated herein in its entirety by reference.

1. A display panel comprising an array substrate and an opposite substrate; wherein the array substrate comprises signal lines including at least one of gate routes, and source routes;
the opposite substrate comprises auxiliary routes corresponding to the signal lines, any signal line being electrically connected with its corresponding auxiliary route, and the signal lines being insulated from each other, and any signal line and an auxiliary route electrically connected with it being configured to transmit signals to an electrode electrically connected with the signal line.

2. The display panel according to claim 1, wherein the signal lines comprise source routes including data lines in an display area; and
the auxiliary routes comprise first auxiliary routes corresponding to the source routes.

3. The display panel according to claim 2, wherein the source routes further comprise data line leads electrically connected with the data lines and located in the wiring area; and
the first auxiliary routes have projections overlapping those of the data lines and the data line leads in a direction perpendicular to the display panel and are electrically connected by at least two separate connection points.

4. The display panel according to claim 1, wherein the signal lines comprise gate routes including gate lines in the display area; and
the auxiliary routes comprise second auxiliary routes corresponding to the gate routes.

5. The display panel according to claim 4, wherein the gate routes further comprise gate line leads electrically connected with the gate lines and located in the wiring area, one end of each gate line being electrically connected with the gate line lead, and other end being electrically connected with the gate line lead or the second auxiliary route.

6. The display panel according to claim 5, wherein for any gate line, both ends thereof are electrically connected with a gate line lead; and
projections of the second auxiliary routes overlap at least projections of the gate line leads in the direction perpendicular to the display panel.

7. The display panel according to claim 5, wherein for any gate line, one end thereof is electrically connected with a gate line lead; and
with respect to the midline of the display panel perpendicular to the gate line, the gate line leads are disposed alternately and the second auxiliary routes and the gate line leads are disposed symmetrically.

8. The display panel according to claim 5, wherein in a direction perpendicular to the gate lines, the wiring area comprises a first wiring area and a second wiring area opposite to each other; and the gate line leads extend into the first wiring area; and
in case that the signal lines comprise source routes and the source routes further comprise data line leads, the data line leads extend into the first wiring area.

9. The display panel according to claim 4, wherein in case the auxiliary routes further comprise first auxiliary routes, the first auxiliary routes and the second auxiliary routes are disposed in a same layer.

10. The display panel according to claim 1, wherein any signal line and an auxiliary route corresponding to it are electrically connected by conductive adhesive in the wiring area.

11. A manufacturing method of a display panel, comprising:
preparing an array substrate and an opposite substrate; wherein the array substrate comprises signal lines including at least one of gate routes, and source routes, the signal lines being insulated from each other; and the opposite substrate comprises auxiliary routes corresponding to the signal lines, and
assembling the array substrate and the opposite substrate to form a cell to electrically connect any signal line with an auxiliary route corresponding to it by conductive adhesive; wherein the signal line and the auxiliary route electrically connected with it are used to transmit signals to an electrode electrically connected with the signal line.

12. The manufacturing method according to claim 11, wherein the signal lines comprise source routes and gate routes, the auxiliary routes comprise first auxiliary routes corresponding to the source routes and second auxiliary routes corresponding to the gate routes, the first auxiliary routes and the second auxiliary routes being formed by a single patterning process.

13. The manufacturing method according to claim 12, wherein the source routes comprise data lines in the display area and data line leads in the wiring area; projections of the first auxiliary routes overlap those of the data lines and the data line leads in a direction perpendicular to the display panel and are electrically connected by at least two separate connection points;
the gate routes comprise gate lines in the display area; and
the second auxiliary routes are located in the wiring area.

14. A display device comprising the display panel according to claim 1 and a drive module configured to provide signals to signal lines.

15. The display panel according to claim 2, wherein the signal lines comprise gate routes including gate lines in the display area; and
the auxiliary routes comprise second auxiliary routes corresponding to the gate routes.

16. The display panel according to claim 3, wherein the signal lines comprise gate routes including gate lines in the display area; and
the auxiliary routes comprise second auxiliary routes corresponding to the gate routes.

17. The display panel according to claim 4, wherein for any gate line, both ends thereof are electrically connected with a gate line lead; and
projections of the second auxiliary routes overlap at least projections of the gate line leads in the direction perpendicular to the display panel.

18. The display panel according to claim 4, wherein for any gate line, one end thereof is electrically connected with a gate line lead; and
with respect to the midline of the display panel perpendicular to the gate line, the gate line leads are disposed alternately and the second auxiliary routes and the gate line leads are disposed symmetrically.

19. The display device according to claim 14, wherein the signal lines comprise source routes including data lines in an display area; and
the auxiliary routes comprise first auxiliary routes corresponding to the source routes.

20. The display device according to claim 19, wherein the source routes further comprise data line leads electrically connected with the data lines and located in the wiring area; and
the first auxiliary routes have projections overlapping those of the data lines and the data line leads in a direction perpendicular to the display panel and are electrically connected by at least two separate connection points.
